(19) United States
(12) Patent Application Publication
(10) Pub. No.: US 2003/0128638 A1
(43) Pub. Date: Jul. 10, 2003

(54) Optical disk device and gain control method used therefor

(76) Inventor: Hiromi Joshita, Fukuoka (JP)

Correspondence Address: RATNERPRESTIA, P O BOX 980, VALLEY FORGE, PA, 19482-0980, US

(21) Appl. No.: 10/317,897

(22) Filed: Dec. 12, 2002

(30) Foreign Application Priority Data
Dec. 14, 2001 (JP) 2001-381355

(51) Int. Cl. G11B 7/095

(52) U.S. Cl. 369/44.29; 369/53.24

(57) ABSTRACT

An optical disk device that performs a stable seek operation even in the movement from a recorded surface to an unrecorded surface. The optical disk device has gain corrector 30. The gain corrector comprises memory section 22 for storing a gain control value of the AS control system before a rough seek, movement determining section 23 for determining if the rough seek has made a movement from a recorded surface to an unrecorded surface, and computing and setting section 24 for correcting a gain control value of the tracking control system. When it is determined that the rough seek is performed from a recorded surface to an unrecorded surface, the gain corrector corrects the gain control value of the tracking control system according to the rate of change in the gains of the AS control system before and after the rough seek. This correction can prevent saturation of gains of the tracking control system and thus provide a stable rough seek.

### FIELD OF THE INVENTION

The present invention relates to an optical disk device that controls gains in order to keep constant output of the entire servo system for the focus and tracking control, and a method of controlling the gains.

### BACKGROUND OF THE INVENTION

In a conventional optical disk device, information recorded on an optical disk is read by irradiating the recorded surface on the optical disk with laser light, receiving light reflected therefrom, and detecting changes in the reflectance, using an optical pickup. However, surface deflection or up-down movement of the disk surface while the disk is rotating cannot be avoided by any means. Therefore, at reproducing and recording data, laser light is controlled using the objective lens in the optical pickup so that a fixed focal length is always maintained with respect to the signal recording surface of the optical disk. The signal used for detecting the focus error at this time is a focus error signal (hereinafter referred to as a “FE signal”).

On the other hand, eccentricity of the central hole of the optical disk, or eccentricity caused by displacement of the optical disk when it is clamped on the turntable results in eccentric placement of the tracks in a spiral manner with respect to the laser spot radiated from the optical pickup, at rotation of the optical disk. A signal used for accurately tracking such tracks is a tracking error signal (hereinafter referred to as a “TE signal”). A signal indicating the amount of light reflected from the optical disk when the recording surface of the optical disk is irradiated with laser light is an AS signal (i.e. an all sum signal, in which all signals from detecting elements of any signal detection method are summed up).

In a conventional optical disk device, input gains of the aforementioned FE signal, TE signal, and AS signal are controlled to optimum values using an automatic gain control (hereinafter abbreviated as “AGC”) circuit that keeps constant output of the entire servo system in order to minimize disturbances caused by variations in optical disks (e.g. a DVD-RAM, DVD-R, DVD-RW, CD-R, and CD-RW) and changes in the amount of reflected light.

First, a structure of a conventional optical disk device is described using FIG. 4. FIG. 4 shows optical disk 1, i.e. a disk-like recording medium having a signal recording surface, disk motor 2 for rotating optical disk 1, optical pickup 3 for driving an objective lens in a focusing direction to generate a light spot through the objective lens onto the signal recording surface of optical disk 1, and traverse mechanism 4 for moving optical pickup 3 in the direction of the radius of optical disk 1. Driver 5 includes a motor driver for controlling disk motor 2, a laser driver for controlling laser light, and traverse driver for controlling traverse mechanism 4. FIG. 4 further shows RF amplifier 6, signal processor 7 for restoring information according to reproducing signals amplified by RF amplifier 6, servo controller 8, central processing unit (CPU) 9 for controlling the entire operations of the optical disk device.

In the conventional optical disk device, the input gains of the FE signal, TE signal, and AS signal are controlled using the AGC circuit that controls the gains of the servo loop in order to minimize disturbances caused by variations in optical disks, changes in the amount of reflected light, or the like. Next, the AGC circuit is briefly described. FIG. 5 shows a structure of the AGC circuit in the optical disk device.

A/D converters 11 shown in FIG. 5 perform A/D conversion of the TE signal, FE signal, and AS signal. The input gains of the converted TF signal and FE signal are switched by TE signal input gain controller (TEAGCG) 12 and FE signal input gain controller (FEAGCG) 13, respectively, so that the output of the entire servo system can be maintained constant. Values of TEAGCG12 and FEAGCG 13 are converted and then corrected using AS digital value 17, i.e. a digital value of the AS signal subjected to A/D conversion, as a basis and according to prepared gain table 19. In a similar manner, a value of AS signal input gain controller (ASAGCG) 14 is corrected.

Thereafter, the digital values of the TE signal and FE signal that have been controlled by TEAGCG 12 and FEAGCG 13, (TE digital value 15 and FE digital value 16, respectively) are subjected to D/A conversion at D/A converters 18. Each of the signals obtained after the D/A conversion is supplied as a tracking drive signal (TRDRV) and focus drive signal (FODRV). Each of the initial values of TEAGCG 12, FEAGCG 13, and ASAGCG 14 is preset. However, as a tracking control is turned off during a rough seek operation which allows the movement of a traverse transmission mechanism, the AGC circuit for the gain of the tracking control system does not operate in that period.

In the conventional optical disk device hereinabove described, as the AGC circuit for the tracking control system does not operate during the rough seek period, the gain control value of the tracking control system remains the control value just before the start of the rough seek. For this reason, for a recording media in which recorded regions and unrecorded regions coexist, such as a DVD-RAM, DVD-R, DVD-RW, CD-R, and CD-RW, when a rough seek is performed from a recorded surface to an unrecorded surface or vice versa, the gain control value of the tracking control system immediately after the rough seek is sometimes different from the ideal value.

Even when a rough seek is performed from a recorded surface to an unrecorded surface, the gain control value of the tracking system is set to a value larger than the ideal value. As a result, the gain may be saturated and may cause tracking errors.

For example, the AGC at a rough seek is described according to FIG. 6. FIG. 6 is a schematic diagram showing the AGC control values when a rough seek is performed from recorded surface 20 to unrecorded surface 21 on a DVD-RAM or the like. The diagram shows changes in the AGC control values. When a rough seek is started on this optical disk 1 in which recorded surface 20 and unrecorded surface 21 coexist, the seek operation is performed while the gain control value of the tracking control system (hereinafter referred to as the “TEAGCG control value”) maintains the final TEAGCG control value. The final TEAGCG control value is equal to a value immediately before the rough seek starts and the tracking control is ON. Then, after completion of the seek operation, tracking control is recovered and the TEAGCG control value does not change until the AGC circuit for the tracking control system operates. For this reason, immediately after the rough seek from recorded surface 20 to unrecorded surface 21, a TEAGCG control value is set larger than the ideal value. This may saturate the output of the servo tracking system and cause tracking errors. On the other hand, a gain control value of the AS system (hereinafter referred to as an “ASAGCG control value”) indicating the amount of reflected light varies in proportional to the amount of light reflected from optical disk 1 without any interruption.

### SUMMARY OF THE INVENTION

Therefore, the present invention aims to provide an optical disk device and a gain control method capable of maintaining a constant servo loop gain and preventing tracking errors even when a rough seek is performed from a recorded surface to an unrecorded surface on an optical disk.

The optical disk device of the present invention is characterized in having:

a determining section for determining whether a seek is performed on a recorded surface or an unrecorded surface, when a recorded surface and an unrecorded surface coexist in an optical disk;

a memory section for temporarily storing an input gain control value of an AS signal immediately before the rough seek; and

a computing and setting section for correcting a gain value of a tracking control system, using the input gain control values of the AS signal immediately before and after the rough seek, when the rough seek is performed from the recorded surface to the unrecorded surface.

This device can maintain a constant servo loop gain and prevent tracking errors even when a rough seek is performed from a recorded surface to an unrecorded surface on an optical disk.

The method of controlling a gain of the tracking control system of the present invention is characterized in that correction is made by computing the gain value of the tracking control system according to the rate of change in gains of the AS control system.

This method can maintain a constant servo loop gain and prevent tracking errors even when a rough seek is performed from a recorded surface to an unrecorded surface on an optical disk.

### BRIEF DESCRIPTION OF THE DRAWINGS

FIG. 1 shows a structure of an optical disk device in accordance with a first exemplary embodiment of the present invention.

FIG. 2 shows a structure of a gain corrector in the optical disk device of FIG. 1.

FIG. 3 is a flowchart showing operations of correcting a gain of a tracking control system in the optical disk device of FIG. 1.

FIG. 4 shows a structure of a conventional optical disk device.

FIG. 5 shows a structure of an automatic gain control (AGC) circuit of the conventional optical disk device.

FIG. 6 is a schematic diagram showing AGC control values when a rough seek is performed from a recorded surface to an unrecorded surface in the conventional optical disk device.

### PREFERRED EMBODIMENT OF THE INVENTION

A first exemplary embodiment of the present invention is described hereinafter with reference to the accompanying drawings. The subject medium of the present invention is a medium in which recorded regions and unrecorded regions coexist or can coexist, more specifically an optical disk, especially a medium, such as a DVD-RAM, DVD-R, DVD-RW, CD-R, and CD-RW. For simplicity, such a medium is simply referred to as an “optical disk” in the following description.

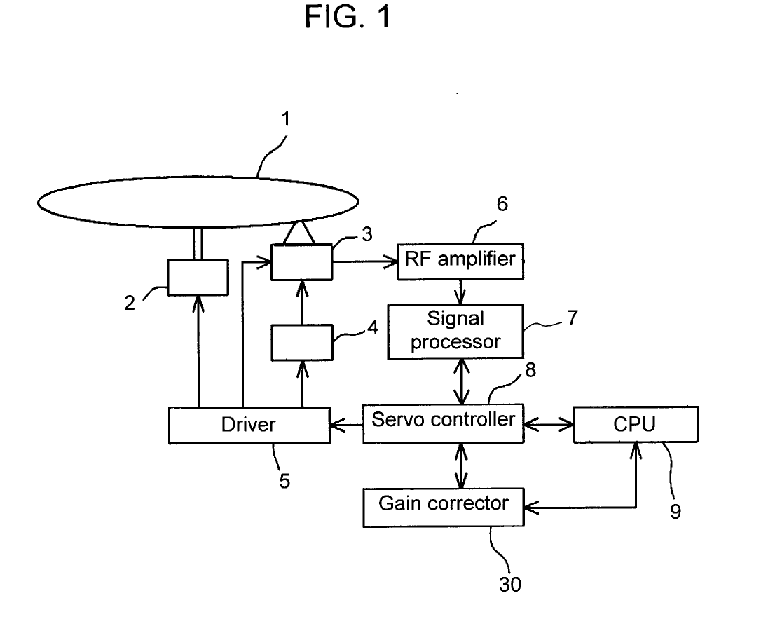

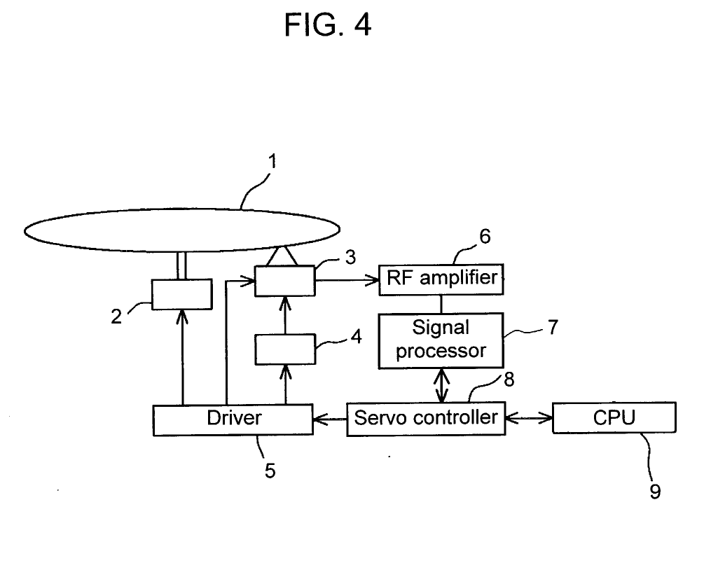

FIG. 1 shows a structure of an optical disk device of the first exemplary embodiment of the present invention. Elements similar to those of the conventional optical disk device shown in FIG. 4 have the same reference numbers, and the descriptions of those elements are omitted.

FIG. 1 shows an optical disk device of the first embodiment of the present invention that comprises optical disk 1, disk motor 2, optical pickup 3, traverse mechanism 4, driver 5, RF amplifier 6, signal processor 7, servo controller 8, central processing unit (CPU) 9, and gain corrector 30 for correcting gains of a tracking control system in servo controller 8.

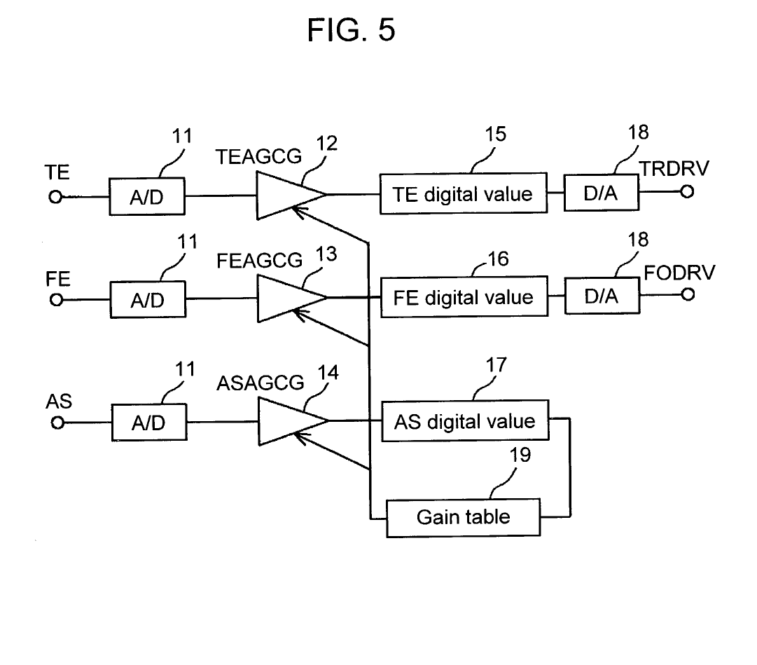

In the optical disk device of the first embodiment, an automatic gain control (AGC) circuit that maintains constant output of the entire servo system is used in order to minimize disturbances caused by variations in optical disk 1 and changes in the amount of reflected light. The AGC circuit controls the input gains of the FE signal, TE signal, and AS signal to optimum values. In FIG. 1 showing a structure of the optical disk device, the AGC circuit is included in signal processor 7. The FE signal, TE signal, and AS signal processed via signal processor 7 (the AGC circuit) are fed into servo controller 8. As the AGC circuit of the present invention, a circuit identical with a conventional AGC circuit shown in FIG. 5 is used. In other words, the input gains of the TE signal and FE signal subjected to A/D conversion are switched by TE signal input gain controller (TEAGCG) 12 and FE signal input gain controller (FEAGCG) 13, respectively, so that the output of the entire servo system is maintained constant. Values of TEAGCG 12 and FEAGCG 13 are converted using AS digital value 17 as a basis and according to prepared gain table 19. The AS digital value 17 is a digital value of the AS signal subjected to A/D conversion,

In a similar manner, a value of AS signal input gain controller (ASGCG) 14 is corrected. Thereafter, the digital values of the TE signal and FE signal that have been controlled by TEAGCG 12 and FEAGCG 13 (TE digital value 15 and FE digital value 16, respectively), are subjected to D/A conversion at D/A converters 18. Each of the signals obtained after D/A conversion is supplied as a tracking drive signal (TRDRV) and focus drive signal (FODRV). Each of the initial values of TEAGCG 12, FEAGCG 13, and ASAGCG 14 is preset.

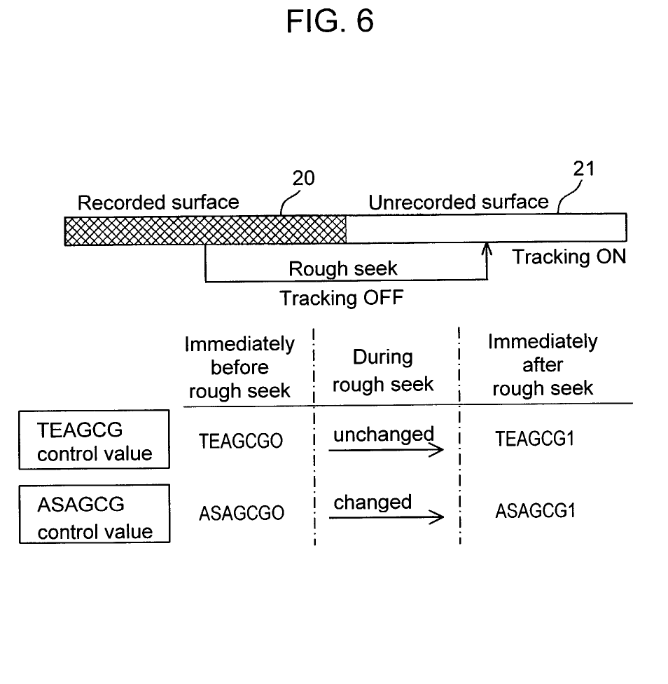

Next, a rough seek operation shown in FIG. 6 is described. When a rough seek starts from recorded surface 20 to unrecorded surface 21, the seek operation is performed while the gain control value of the tracking control system (hereinafter referred to as the “TEAGCG control value”) maintains the final TEAGCG control value. The final TEAGCG control value is a value immediately before the rough seek starts on that occasion tracking is ON. Then, after completion of the seek operation, tracking control is recovered and the TEAGCG control value does not change until the AGC circuit for the tracking control system operates.

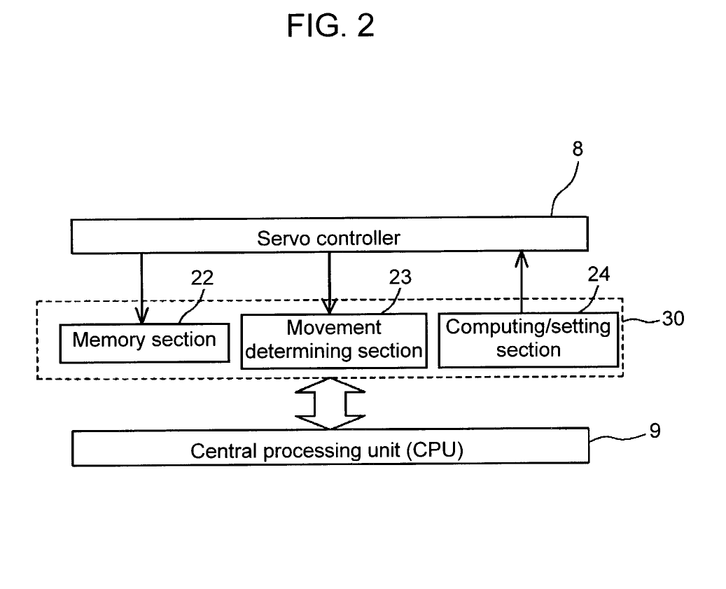

However, correction is made to the TEAGCG control value according to the ASAGCG control value that always varies in proportion to the amount of light reflected from the disk surface even while the tracking control is turned off. The correction of the first embodiment is made by multiplying the TEAGCG control value by the rate of change in the ASAGCG control values before and after the rough seek. A corrector for the TEAGCG control value is described hereinafter with reference to FIG. 2. FIG. 2 shows a structure of a gain corrector 30 in the optical disk device of FIG. 1.

In FIG. 2, gain corrector 30 comprises memory section 22, movement determining section 23, and computing/setting section 24.

Memory section 22 stores ASAGCG control values obtained from servo controller 8 and temporarily stores an ASAGCG control value immediately before the rough seek. Movement determining section 23 for determining the movement from recorded surface 20 to unrecorded surface 21 determines whether or not a rough seek is performed from recorded surface 20 to unrecorded surface by checking the amount or rate of change in the ASAGCG control values before and after the rough seek. Computing/setting section 24 corrects the TEAGCG control value by multiplying the TEAGCG control value by the rate of change in the ASAGCG control values before and after the rough seek.

Although it is not stated in the first embodiment, movement determining section 23 can determine not only a rough seek performed from recorded surface 20 to unrecorded surface 21 but also a rough seek performed from unrecorded surface 21 to recorded surface 20 in reverse by checking the amount or rate of change in the ASAGCG control values.

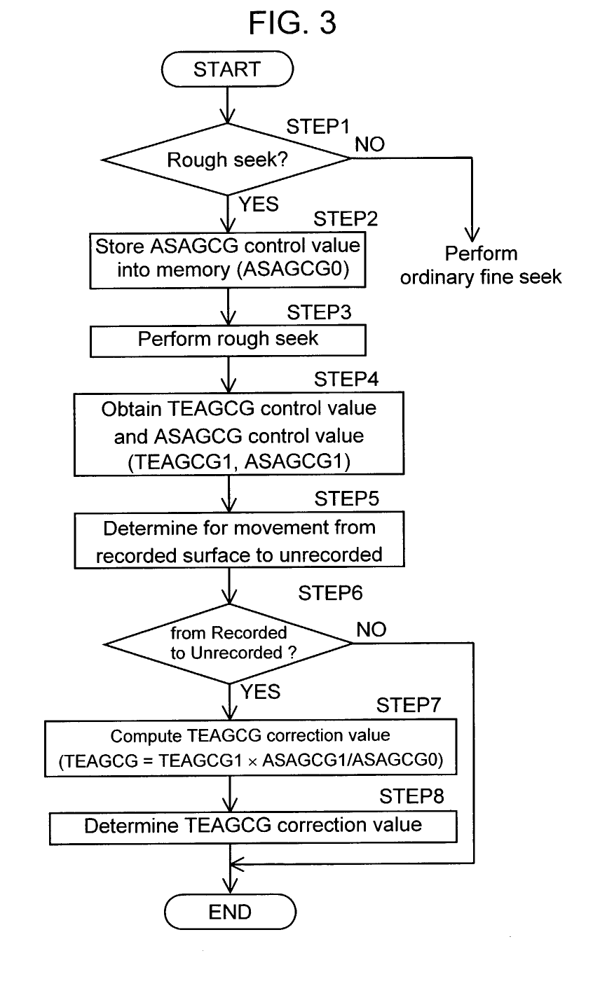

Described next is a method of controlling a gain of the tracking control system in the optical disk device of the first embodiment structured as above. FIG. 3 is a flowchart showing a process of correcting a gain of the tracking control system in the optical disk device of FIG. 1.

First, in optical disk 1 in which a recoded surface and an unrecorded surface coexist, such as a DVD-RAM, it is determined whether or not a rough seek involving a traverse movement is performed (Step 1). An ASAGCG control value obtained from the AGC circuit immediately before the rough seek is temporarily stored in memory section 22 in gain corrector 30 (Step 2). The value stored at this time is set to [ASAGCG0].

After [ASAGCG0] is stored, an actual rough seek is performed (Step3). After completion of the rough seek, a TEAGCG control value and an ASAGCG control value are obtained from the AGC circuit (Step 4). Each of the values obtained at this time is set to [TEAGCG1] and [ASAGCG1].

Next, it is determined whether or not a movement is made from recorded surface 20 to unrecorded surface 21 during the rough seek (Step 5). Comparison of the amount or rate of change in the ASAGCG control values obtained before and after the rough seek ([ASAGCG0] and [ASAGCG1]) with a prepared threshold value of the amount or rate of change determines whether or not the movement is made from a recorded surface to unrecorded surface.

The threshold value depends on the difference in the amount of reflected light between recorded surface 20 and unrecorded surface 21. The threshold value is prepared for each optical disk, such as a DVD-RAM, DVD-R, and DVD-RW. In the first embodiment, when the threshold value determines that the movement is made from recorded surface 20 to unrecorded surface 21 (Step 6), the TEAGCG control value is corrected (Step 7).

Equation (1) is employed as the method of computing the correction value, in that [TEAGCG1] and [ASAGCG1]/[ASAGCG0] is multiplied.

[TEAGCG]=[TEAGCG1]×[ASAGCG1]/[ASAGCG0] (1)

Where [TEAGCG1] is a value obtained after the rough seek and [ASAGCG1]/[ASAGCG0] shows the rate of change in the ASAGCG before and after the rough seek. In this method, the TEAGCG correction value is computed on the assumption that the TEAGCG has the rate of change same as that of the ASAGCG. The TEAGCG correction value obtained in this manner is used to set the actual TEAGCG control value (Step 8).

In the optical disk device of the first embodiment, the tracking control is not turned on automatically by the LSI after the rough seek. The tracking control is turned on by the software after the correction of the TEAGCG control value.

As hereinabove described, the first embodiment of the present invention can provide the following advantage. In optical disk 1 in which a recorded surface and an unrecorded surface coexist, such as a DVD-RAM, saturation of a gain of the tracking control system can be prevented and a stable rough seek operation can be performed even when the rough seek makes a movement from recorded surface 20 to unrecorded surface 21.

What is claimed is:

1. An optical disk device having:
an optical pickup for generating a light spot through an objective lens onto a signal recording surface on an optical disk; and
an automatic gain control circuit for maintaining constant output of an entire servo system;
wherein said automatic gain control circuit controls input gains of:
a focus error signal;
a tracking error signal; and
an all sum (AS) signal indicating an amount of light reflected from the optical disk, the signals all obtained through said optical pickup; and
wherein said automatic gain control circuit includes:
a determining section for determining on which one of a recorded surface and an unrecorded surface on the optical disk a rough seek is performed;
a memory section for temporarily storing an input gain control value of the AS signal immediately before the rough seek; and
a computing and setting section for correcting the gain value of the tracking error signal according to the input gain control values of the AS signal before and after the rough seek, in response to determination of the rough seek performed between the recorded surface and the unrecorded surface.

2. The optical disk device of claim 1, wherein the optical disk is one selected from a rewritable DVD-RAM disk, recordable DVD and CD, and rewritable DVD and CD.

3. The optical disk device of claim 1, wherein said determining section makes determination by comparing a change in the input gain control values of the AS signal before and after the rough seek with a selected and predetermined threshold value.

4. The optical disk device of claim 3, wherein the optical disk is one selected from a rewritable DVD-RAM disk, recordable DVD and CD, and rewritable DVD and CD, and said determining section selects the threshold value according to a kind of the optical disk.

5. The optical disk device of claim 1, wherein said computing and setting section corrects a rate of change in the gain values of the tracking error signal so that the rate of change is proportional to a rate of change in the input gain control values of the AS signal before and after the rough seek.

6. A method of controlling a gain of an optical disk device, said device having:
an optical pickup for generating a light spot through an objective lens onto a signal recording surface on an optical disk; and
an automatic gain control circuit for maintaining constant output of an entire servo system with respect to a focus error signal, a tracking error signal, and an all sum (AS) signal, the signals all obtained through said optical pickup, said automatic gain control circuit including:
a determining section for determining on which one of a recorded surface and an unrecorded surface a rough seek is performed;
a memory section for temporarily storing an input gain control value of the AS signal immediately before the rough seek; and
a computing and setting section for correcting a gain value of a tracking error signal according to the input gain control values of the AS signal immediately before and after the rough seek;
said method comprising:
storing temporarily a control value immediately before the rough seek into said memory section, when the rough seek is performed;
obtaining a new control value after completion of the rough seek;
determining, using said determining section, on which one of a recorded surface and an unrecorded surface the rough seek is performed; and
correcting a gain value of the tracking control system using said computing and setting section, when it is determined that the rough seek is performed between the recorded surface and the unrecorded surface.
